(19) United States
(12) Patent Application Publication
(10) Pub. No.: US 2025/0165624 A1
(43) Pub. Date: May 22, 2025

(54) APPARATUS AND METHOD FOR MOBILE APPLICATION ENCRYPTION

(71) Applicant: Sertainty Corporation, Nashville, TN (US)

(72) Inventors: Richard Streeter, Lebanon, TN (US); Honore Kamssu, Brentwood, TN (US); Behzad Nadji, Tiburon, CA (US); James Timothy White, Pensacola, FL (US)

(21) Appl. No.: 18/957,201

(22) Filed: Nov. 22, 2024

Related U.S. Application Data
(60) Provisional application No. 63/602,208, filed on Nov. 22, 2023.

(51) Int. Cl. G06F 21/60

(52) U.S. Cl. CPC G06F 21/602

(57) ABSTRACT

In an embodiment a system for encrypting data created and used by applications on mobile devices is presented. The system includes a mobile device having at least a sensor and a mobile application executable on the mobile device. The mobile application, upon execution, is programmed to retrieve sensor data of the mobile device through the at least a sensor. The mobile application is programmed to generate a secure data file within the mobile application. The secure data file is configured to receive the sensor data. The mobile application is programmed to transfer the sensor data directly into the secure data file, bypassing interactions with any default applications of the mobile device. The sensor data is inaccessible to a default application of the mobile device. The mobile application is programmed to store the sensor data within the secure data file.

### CROSS-REFERENCE TO RELATED APPLICATIONS

This application claims priority to, and the benefit of, U.S. Prov. App. No. 63/602,208, filed Nov. 22, 2023, the entirety of which is incorporated herein by reference.

### TECHNICAL FIELD

This disclosure relates to apparatuses and methods for mobile applications. In particular, the current disclosure relates to apparatuses and methods for encrypting data utilized by mobile applications.

### BACKGROUND

Mobile devices create and store images, videos, audio and many other types of data files in an unprotected state. Security of images, videos, or audio files stored by modern applications can be improved.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an embodiment a system for encrypting data created and used by applications on mobile devices is presented. The system includes a mobile device having at least a sensor and a mobile application executable on the mobile device. The mobile application, upon execution, is programmed to retrieve sensor data of the mobile device through the at least a sensor. The mobile application is programmed to generate a secure data file within the mobile application. The secure data file is configured to receive the sensor data. The mobile application is programmed to transfer the sensor data directly into the secure data file, bypassing interactions with any default applications of the mobile device. The sensor data is inaccessible to a default application of the mobile device. The mobile application is programmed to store the sensor data within the secure data file. The secure data file is hidden from any of the default applications of the mobile device.

In another embodiment, a method of mobile application encryption using a computing device is presented. The method includes executing a mobile application on a mobile device, the mobile device having at least one sensor. The method includes retrieving, by the mobile application, sensor data of the mobile device through the at least a sensor. The method includes generating, by the application, a secure data file configured to receive the sensor data. The method includes transferring, by the mobile application, the sensor data directly into the secure data file of the mobile application, bypassing interaction with any default applications of the mobile device. The sensor data is inaccessible to any default applications of the mobile device. The method includes storing the sensor data within the secure data file controlled by the mobile application. The data within the secure data file is inaccessible by an operating system of the mobile device and even the application that created the secure file if it is configured to do so.

### BRIEF DESCRIPTION OF THE DRAWINGS

The foregoing aspects and many of the attendant advantages of embodiments of the present disclosure will become more readily appreciated as the same become better understood by reference to the following detailed description, when taken in conjunction with the accompanying drawings.

FIG. 1 illustrates an exemplary embodiment of a block diagram of an apparatus for mobile application encryption.

FIG. 2 illustrates an exemplary embodiment of a schematic diagram that illustrates an exemplary use case for an embodiment of the present disclosure.

FIG. 3 illustrates an exemplary embodiment of a process of recording sensor data using the apparatus in FIG. 1.

FIG. 4 is a flowchart of a method of mobile application encryption.

FIG. 5 is an exemplary embodiment of a block diagram of a computing device that may be implemented in the apparatuses, systems, and/or methods described herein.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION OF EXEMPLARY EMBODIMENTS

Aspects of the present invention can be used to securely record sensor data captured by a mobile device without the sensor data interacting with any of the mobile device's other applications or operating system functionalities. Embodiments of the present invention can be used to record videos, images, audio files, and/or other data and communicate that data to another computing device while leaving no trace of the recording's contents on the mobile device. In an embodiment, an application can be used to generate one or more secure data files that may store sensor data within the application and be inaccessible to any other application or operating system on the mobile device the application may be running on. Embodiments of the present invention can be used to provide a secure sensor system that covertly records sensor data.

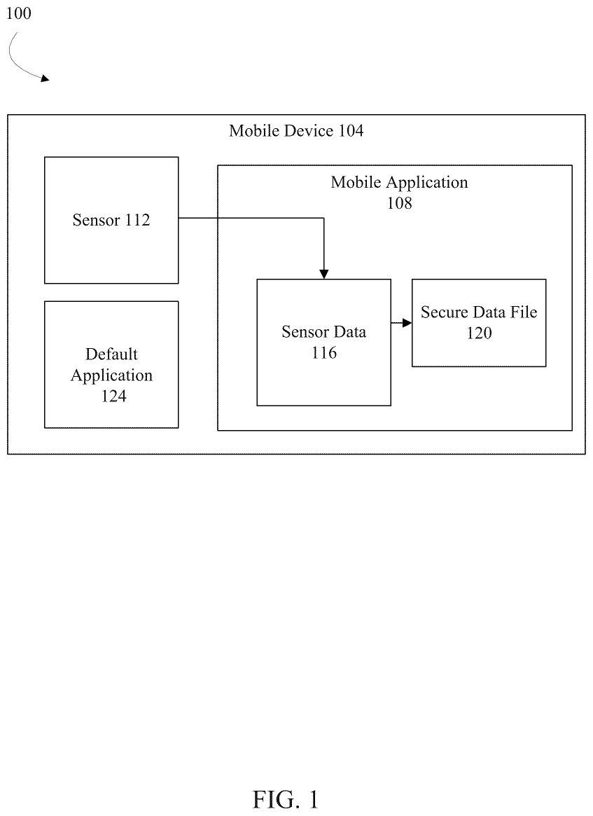

Referring now to FIG. 1, a system 100 for mobile application encryption is presented. The system 100 includes mobile device 104. A “mobile device” as used in this disclosure is any portable device having a processor. Mobile device 104 may include, but is not limited to, smartphones, laptops, tablets, drones, smartwatches, Internet of Things (IoT) devices, Raspberry PI's, Arduinos, and/or other devices. Mobile device 104 may run an operating system such as, but not limited to, Windows, MacOS, Android, IOS, Linux, real-time operating systems (RTOS), and/or other operating systems. Mobile device 104 may have a display, such as, but not limited to, an liquid crystal display (LCD), organic light emitting diode (OLED), active matrix organic light emitting diode (AMOLED), or other display. In some embodiments, mobile device 104 may have a touch screen. A touch screen may include, but is not limited to, surface capacitive touch, projected capacitive touch, 5-Wire resistive, and the like. In embodiments, mobile device 104 may include any device with a processor. For instance, mobile device 104 may include a health tracker such as a FitBit, Whoop band, heart rate monitor, or other health tracker. Mobile device 104 may include Internet of Things (IoT) devices, such as, but not limited to, smart home devices, smart appliances, edge devices, and/or other devices.

Mobile device 104 may include sensor 112. A “sensor” as used in this disclosure is a device capable of measuring a physical property. Physical properties may include, but are not limited to, acceleration, temperature, locations, altitudes, imagery, audio, and/or other physical properties. Sensor 112 may include an imaging sensor, transducer, microphone, global positioning sensor (GPS), thermometer, gyroscope, heartbeat sensor, electrocardiogram (EKG) sensors, blood oxygen sensors, and/or other measuring devices. Mobile device 104 may have a plurality of sensors 112, such as two or more cameras, camera arrays, microphones, microphone arrays, and/or other combinations of sensors. Sensor 112 may include a camera. A “camera” as used in this disclosure is any device capable of capturing image data. A camera may include multiple lenses and/or imaging sensors, such as a camera array, without limitation. Sensor 112 may be configured to generate sensor data 116. Sensor data 116 may include information relating to one or more physical properties detected by sensor 112. Sensor data 116 may include, but is not limited to, images, videos, audio samples, and/or other recordings. Sensor data 116 may include audio received from an internal camera of mobile device 104, audio solely received by an internal microphone of mobile device 104, and/or a combination thereof, without limitation. Sensor data 116 may include, without limitation, biometric data, physiological data, heartbeats, temperatures, accelerations, altitudes, longitudes, GPS locations, and/or other data. For instance, sensor data 116 may include a number of steps calculated by a pedometer. In some embodiments, sensor data 116 may include metadata. Metadata may include information such as, but not limited to, device type, times, dates, locations, data sizes, authors, and the like.

In some embodiments, mobile device 104 is operable to run mobile application 108. A “mobile application” as used in this disclosure is a program capable of running on a mobile device. Mobile application 108 may be a software program that encrypts data agnostic to one or more systems of a computing device, such as mobile device 104. Although mobile application 108 is described in the context of a camera application below, it should be noted that mobile application 108 can be in the form of any application, such as, but not limited to, heart rate monitors, pedometers, audio recording applications, GPS applications, and/or other applications. Mobile application 108 may operate in a background setting of a computing device.

Mobile application 108 may be installed on mobile device 104, such as through a wired or wireless connection. In some embodiments, a user may execute mobile application 108 through a user interface, such as a graphical user interface (GUI). For instance, and without limitation, mobile application 108 may take the form of an application on a home page of mobile device 104. A user may select mobile application 108 through user input such as, but not limited to, mouse input, keyboard input, touch input, and the like. In an embodiment, mobile application 108 executes upon mobile device 104 receiving user input of a selection of mobile application 108. Mobile application 108 may be configured to operate one or more sensors 112 of mobile device 104. For instance, and without limitation, mobile application 108 may operate one or more sensors 112 such as cameras, microphones, GPS sensors, heartbeat sensors, temperature sensors, gyroscopes, and the like of mobile device 104. Mobile application 108 may operate with the data from one or more sensors 112 instead of one or more default applications 124 of mobile device 104. Mobile application 108 may bypass default application 124, such as by directing sensor data 116 directly to itself instead of interacting with default application 124. Default application 124 may be any application of mobile device 104, such as a camera application, video recording application, audio recording application, heartbeat detection application, blood oxygen application, and/or other applications. Default application 124 may be native to mobile device 104. For instance default application 124 may be a native camera application of mobile device 104. In some embodiments, default application 124 may be a downloaded or installed application from a third party.

In some embodiments, mobile application 108 may provide one or more options to a user through a GUI. Options may include, without limitation, type of sensor 112, recording features utilizing sensor 112, and/or other options. Types of sensors 112 may include camera types, microphone types, heart rate sensor types, and the like. Biometric data may include, without limitation, heart rates, heart rhythms, blood oxygen levels, body compositions, and the like. Physiological data may include, without limitation, heights, weights, ages, and/or other data. Recording features may include, without limitation, image resolutions, video resolutions, color channels, audio effects, and/or other recording features. A user may manually select one or more types of sensors 112 and/or recording features through a GUI of mobile application 108. In other embodiments, one or more types of sensors 112 and/or recording features may be automatically selected by mobile application 108. A user may activate one or more sensors 112 of mobile device 104 through mobile application 108, such as by interacting with a GUI of mobile application 108. As a non-limiting example, a user may take a photo using a camera sensor of mobile device 104 through mobile application 108. Mobile application 108 may directly receive sensor data 116 generated by an activation of one or more sensors 112 of mobile device 104. In an embodiment, sensor data 116 is excluded from one or more default applications 124 of mobile device 104 and instead is directly received at mobile application 108.

Mobile application 108 may generate secure data file 120. A “secure data file” as used in this disclosure is a data file that stores data inaccessible to data management systems of a native device. Secure data file 120 may include an intelligent cipher transfer object (ICTO) file, such as the ICTO file described in U.S. application Ser. No. 17/377,595, filed Jul. 16, 2021, and titled “System and Methods for using Cipher Objects to Protect Data”, which is incorporated in its entirety herein by reference.

Secure data file 120 may be configured to receive sensor data 116. In some embodiments, mobile application 108 generates the secure data file 120 before activation of one or more sensors 112 of mobile device 104. In other embodiments, mobile application 108 generates the secure data file 120 simultaneously with an activation of one or more sensors 112 of mobile device 104. In yet another embodiment, mobile application 108 generates the secure data file 120 after activation of one or more sensors 112 of mobile device 104. In an embodiment, secure data file 120 receives sensor data 116. For instance, secure data file 120 may receive sensor data 116 through mobile application 108 and/or directly from sensors 112. Mobile application 108 may temporarily hold or otherwise store sensor data 116 before transferring sensor data 116 to secure data file 120. In some embodiments, the secure data file 120 may include one or more sets/instances of sensor data. Sensor data 116 may be placed in one or more virtual files within secure data file 120 while activation of one or more sensors 112 occurs. In an embodiment, after a recording using one or more sensors 112 is completed, one or more virtual files of secure data file 120 are closed. The secure data file 120 may be open before and/or during activation of one or more sensors 112 and may be closed after the activation of one or more sensors 112. As a non-limiting example, secure data file 120 may be open to data reception and sensor data 116 may be transferred to secure data file 120 while a photograph is being captured. After the photograph is captured, the secure data file 120 may close. Secure data file 120 may be generated to be inaccessible to any user on mobile device 104. In other embodiments, secure data file 120 may be accessible to a user of mobile device 104. Contents of the secure data file 120, such as sensor data 116, may be agnostic to an operating system of mobile device 104. For instance, mobile device's 104 operating system may be aware of the existence of secure data file 120 may not have knowledge of the contents of secure data file 120. Default configurations of secure data file 120 may be tuned based on mobile device 104, user of mobile device 104, and the like. As a non-limiting example, mobile device 104 may be a specific smartphone, where secure data file 120 may be configured to prevent user access of itself based on the specific smartphone.

Mobile application 108 may store and/or manage a plurality of secure data files 120. For instance, mobile application 108 may generate and/or store a plurality of secure data files 120 over a course of hours, days, weeks, and/or other time periods. In other embodiments, mobile application 108 may manage a single secure data file 120 at a time. Mobile application 108 may be operable to receive user input, such as user instructions regarding secure data file 120. User instructions may include communicating or otherwise sending secure data file 120 to one or more computing devices. For instance, and without limitation, a user may select, through mobile application 108, to send secure data file 120 to a server, laptop, smartphone, or other device. In other embodiments, mobile application 108 automatically sends and/or shares secure data file 120 with one or more computing devices. Mobile application 108 may have one or more triggering events that may cause mobile application 108 to send secure data file 120 to one or more computing devices. Trigger events may include, but are not limited to, time of day, GPS location, time after secure data file 120 is created, battery status of mobile device 104, and the like. As a non-limiting example, mobile application 108 may determine mobile device 104 is leaving a workplace through a GPS signal and may automatically send secure data file 120 to a computing device based on the determination that mobile device 104 is leaving a workplace. Mobile application 108 may be programmed to delete any or all receipt data of a transfer of secure data file 120 to one or more computing devices. Receipt data may be generated during a transfer of secure data file 120 to one or more computing devices and may include information such as, but not limited to, location, IP addresses, MAC addresses, IMEI numbers, sensor data 116 metadata, and the like. Receipt data may be stored within mobile application 108 and may be agnostic to any other applications or systems of mobile device 104. Mobile application 108 may automatically delete receipt data immediately after a transfer of secure data file 120 to one or more computing devices. In some embodiments, mobile application 108 may leave receipt data for one or more transfers of one or more secure data files 120. A user may select various receipt data to keep and/or delete through mobile application 108.

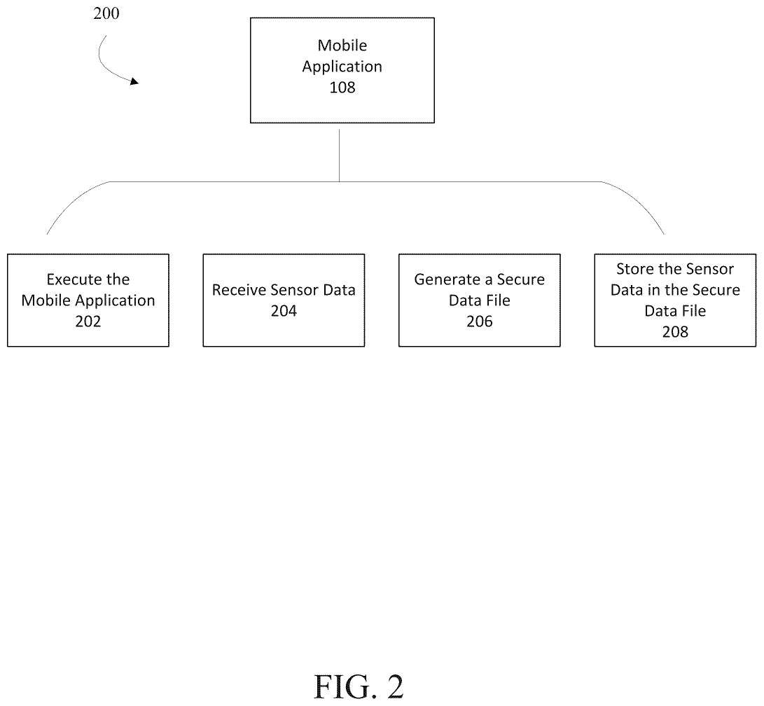

FIG. 2 is an exemplary embodiment of a process 200 of using the secure application described in FIG. 1. Mobile application 108 may be executed at step 202. Execution may occur via user input, such as selection of mobile application 108 through a mobile device, such as mobile device 104 as described above with reference to FIG. 1, without limitation. In some embodiments, execution of mobile application 108 may include mobile application 108 starting up, awakening from a sleep state, and/or other forms of execution. Mobile application 108 may generate one or more icons, pop-up windows, and the like upon execution. In other embodiments, execution may occur without user input and may happen automatically and/or based on a trigger event such as a time of day, connections of a mobile device with other devices, and the like.

At step 202, mobile application 108 may receive sensor data. Sensor data may include sensor data 116 as described above with reference to FIG. 1, without limitation. Mobile application 108 may communicate directly with one or more sensors of a mobile device, such as, but not limited to, cameras, microphones, gyroscopes, heartbeat sensors, and the like. Operation of sensors by mobile application 108 may occur without interaction with one or more systems of a mobile device, such as a native camera application. Mobile application 108 may activate one or more sensors of a mobile device in various ways, such as, but not limited to, periodic activation, prolonged activation, and the like. For instance, mobile application 108 may periodically take a photo through a camera of a mobile device, record a video through the camera of the mobile device, and the like. A user may manually select a record or other activation button of one or more sensors of a mobile device. In some embodiments, instead of sensor data being transferred via one or more native applications, systems, directories, and the like of a mobile device, the sensor data may be directly transferred to mobile application 108.

At step 204, mobile application 108 generates a secure data file. In some embodiments, this step may happen concurrently with step 202. In other embodiments, step 204 may occur after step 202, without limitation. A secure data file may be configured to receive data from mobile application 108, such as sensor data, without limitation. In some embodiments a plurality of secure data files may be generated. A secure data file may be specific to mobile application 108.

At step 206, sensor data may be stored in a secure data file. Sensor data may include images, videos, audio recordings, heartbeats, heart rhythms, temperatures, accelerations, and/or other data. In some embodiments, sensor data is directly transferred from sensors of a mobile device into a secure data file. A secure data file may close upon a completed transfer of sensor data to the secure data file, in an embodiment. A closing of a secure data file may prevent any additional data from entering the secure data file.

At step 208, the data may be stored within a secure data file generated by mobile application 108 and may not be accessible to one or more native systems of a mobile device. In some embodiments, after step 208 a secure data file may be communicated to one or more computing devices, such as through a wired, wireless, or other connection. In some embodiments, communication may occur based on a trigger event, such as identification by a mobile device of a known computing device, a type of established connection between the mobile device and a computing device, and/or other trigger events. Communication of a secure data file to one or more computing devices may generate receipt data, which may automatically be deleted by mobile application 108. In other embodiments, receipt data may be manually manipulated by a user. For instance a user may view, delete, and/or edit receipt data.

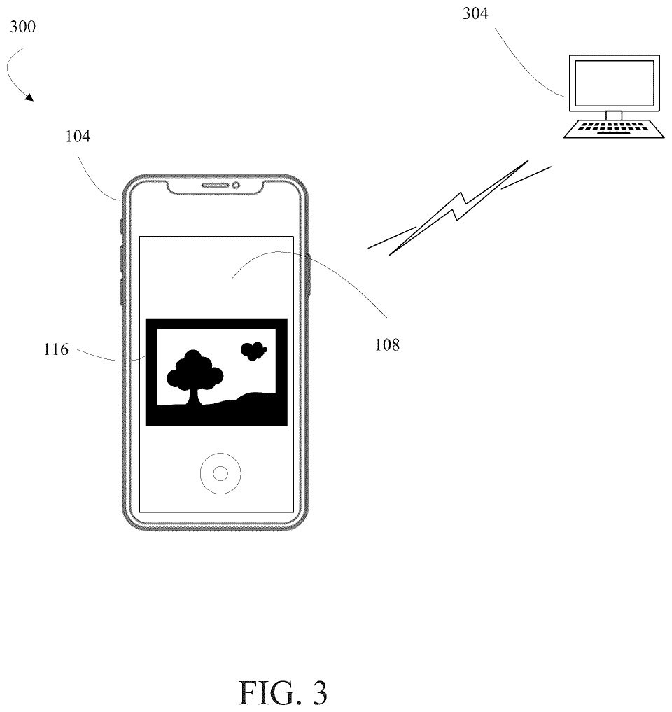

Referring now to FIG. 3, an example 300 of the mobile application 108 described in FIG. 1 is presented. Example 300 includes mobile device 104, mobile application 108, and sensor data 116. Mobile device 104 in example 300 may be in the form of a smartphone, although this is not intended to be a limiting embodiment. Mobile device 104 may include a camera and/or other sensors. Mobile device 104 may run mobile application 108 locally. In some embodiments, mobile device 104 may communicate with a server or other remote computing device to run mobile application 108. Mobile application 108 in example 300 may take the form of a camera application. However, it should be noted that mobile application 108 may take the form of a video recording application, microphone recording application, heartbeat recording application, GPS application, and/or any other application as described throughout this disclosure, without limitation. Mobile application 108 may operate one or more sensors of mobile device 104, such as a camera and a heartrate monitor. In some embodiments, mobile application 108 may operate a camera of mobile device 104 without use of a default camera application or other systems of mobile device 104. Mobile application 108 may provide one or more user options to a user through a GUI, such as a camera icon, video icon, microphone icon, and/or any other icon of a GUI. A user may interact with one or more icons of a GUI of mobile application 108, such as through touch input, mouse input, keyboard input, and the like. Mobile application 108 may be configured to obtain sensor data upon receipt of user input of one or more icons. As a non-limiting example, a user may tap on a camera icon which may cause mobile application 108 to activate a camera of mobile device 104 to take a photograph. In some embodiments, at the same time mobile application 108 activates one or more sensors of mobile device 104, mobile application 108 may generate one or more secure data files. In other embodiments, mobile application 108 may generate one or more secure data files after a recording of an image, video, and the like, is finished.

Mobile application 108 may store sensor data 116, such as a photograph, in a secure data file within mobile application 108. In example 300, sensor data 116 is in the form of a photograph. However, sensor data 116 may be a video, audio recording, GPS location, and/or other sensor data as described throughout this disclosure, without limitation. Mobile application 108 may automatically save sensor data 116 in one or more secure data files. In other embodiments, mobile application 108 may provide one or more options to a user through a GUI to manually save, edit, delete, and the like, sensor data 116. For instance, a user may be provided with an option to save sensor data 116, edit sensor data 116, delete sensor data 116, and/or other options. In some embodiments, mobile application 108 may generate one or more secure data files that may be inaccessible to a user of mobile device 104. In other embodiments, mobile application 108 may generate one or more secure data files with certain user permissions that may allow a user to view and/or modify a secure data file 120.

Mobile application 108 may communicate and/or transfer one or more secure data files to external computer 304. External computer 304 may include any computing device, such as, but not limited to, laptops, desktops, servers, smartwatches, tablets, and the like. Mobile application 108 may utilize communication hardware of mobile device 104, such as antennas, to transfer one or more secure data files to external computer 304 from mobile device 104. For instance, mobile application 108 may utilize Bluetooth, Wi-Fi, cellular data, and the like to transfer one or more secure data files to external computer 304 from mobile device 104. Mobile application 108 may establish a communication link by means of any communication link with external computing device 304 while transmitting one or more secure data files 120. A transfer and/or communication of one or more secure data files between mobile device 104 and external computer 304 may generate receipt data. Receipt data may include, but is not limited to, device identification numbers, times, dates, locations, file sizes, file categories, and the like. Receipt data may be stored within mobile application 108 and may be agnostic to one or more systems of mobile device 104. Mobile application 108 may automatically delete receipt data left by a communication of one or more secure data files to one or more external computers 304. In other embodiments, mobile application 108 may leave receipt data within itself and a user may access the receipt data. Mobile application 108 may be configured to record sensor data 116 through one or more sensors, save the sensor data 116 in a secure data file, and transfer the secure data file to external computer 304 without knowledge of mobile device 104. For instance, mobile device 104 may be unaware of the data of an image that was taken and/or transferred to external computer 304. Mobile device 104 may have no data of an image being taken, a transfer of the image occurring, and/or other operations of mobile application 108. In an embodiment, mobile application 108 may leave no trace of sensor data 116 on mobile device 104, with only external computer 304 having knowledge of the sensor data 116. Mobile application 108 may be programmed to operate agnostic to mobile device 104.

While example 300 discusses the utilization of mobile application 108 in the context of a camera application, it should be noted that mobile application 108 may be used with any sensing device of any mobile device, without limitation.

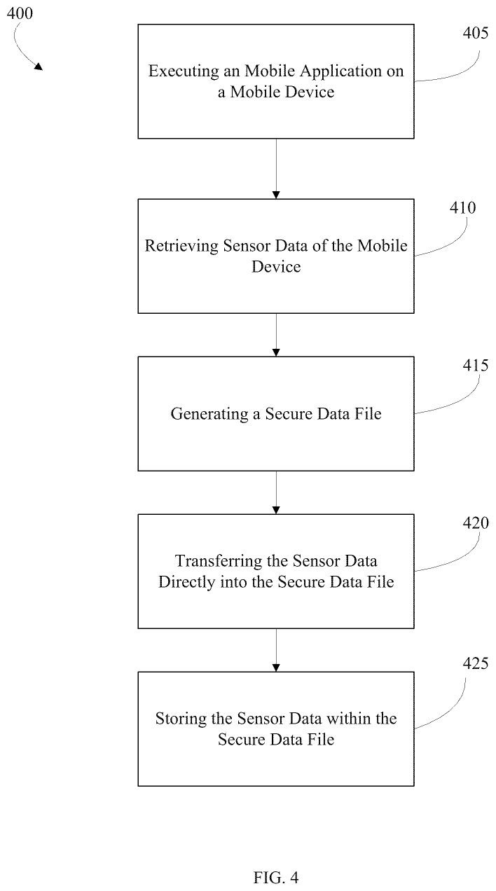

Referring now to FIG. 4, a method 400 of mobile application encryption is presented. At step 405, method 400 includes executing a mobile application on a mobile device. A mobile application may include, without limitation, a camera, video, audio, and/or other application. A mobile device may include, but is not limited to, a smartphone, tablet, smartwatch, laptop, desktop, other device, or a combination of those devices. Execution of a mobile application which produces secure data files 120, on a mobile device may happen in response to a user providing user input to the mobile device, such as selection of an icon of a GUI of the mobile device. In other embodiments, execution of a mobile application may occur through one or more programmatically triggered events, such as, but not limited to, GPS locations of a mobile device, times of day, and the like. This step may be implemented, without limitation, as described above with reference to FIGS. 1-3.

At step 410, method 400 includes retrieving sensor data of the mobile device. Sensor data may be retrieved by a mobile application. For instance, a mobile application may activate one or more sensors of a mobile device. A mobile application may activate one or more sensors of a mobile device without engaging one or more default applications of the mobile device, such as, but not limited to, camera applications, video applications, microphone applications, and the like. Mobile application may retrieve sensor data such as, but not limited to, images, videos, audio recordings, GPS locations, accelerations, gyroscope data, and/or any other sensor data as described throughout this disclosure, without limitation. In some embodiments, sensor data may be directly sent to a mobile application instead of through one or more applications and/or systems of a mobile device. This step may be implemented, without limitation, as described above with reference to FIGS. 1-3.

At step 415, method 400 includes generating a secure data file. A secure data file may be generated within a mobile application. For instance, a mobile application may generate one or more secure data files after step 410 and/or concurrently with step 410. A secure data file may include an encrypted data file configured to receive sensor data, metadata, and/or other data, such as described above with reference to FIG. 1. This step may be implemented, without limitation, as described above with reference to FIGS. 1-3.

At step 420, method 400 includes transferring the sensor data directly into the secure data file. A mobile application may funnel sensor data directly into an open secure data file from one or more sensors of a mobile device. In some embodiments, a mobile application may temporarily store sensor data before transferring the sensor data into a secure data file. This step may be implemented, without limitation, as described above with reference to FIGS. 1-3.

At step 425, method 400 includes storing the sensor data within the secure data file. Storing the sensor data may include closing a secure data file. Closing a secure data file may prevent additional data from entering the secure data file and/or may prevent modification of the secure data file. In some embodiments, a secure data file storing sensor data may be inaccessible to a user of a mobile device. In other embodiments, a secure data file storing sensor data may be accessible to a user of a mobile device. A secure data file storing sensor data may be transferred and/or communicated to one or more computing devices from a mobile device. This step may be implemented, without limitation, as described above with reference to FIGS. 1-3.

It should also be noted that the present implementations can be provided as one or more computer-readable programs embodied on or in one or more articles of manufacture. The article of manufacture can be any suitable hardware apparatus. In general, the computer-readable programs can be implemented in any programming language. The software programs can be further translated into machine language or virtual machine instructions and stored in a program file in that form. The program file can then be stored on or in one or more of the articles of manufacture.

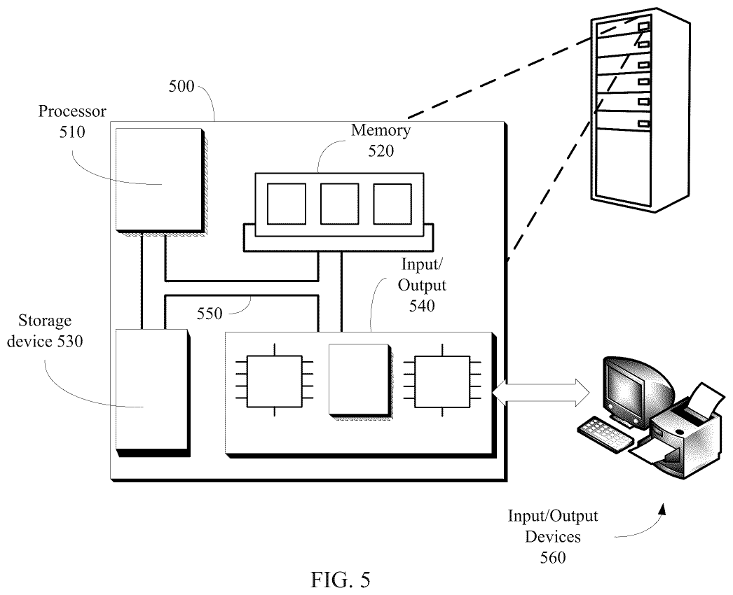

FIG. 5 is a block diagram of an example computer system 500 that may be used in implementing the technology described in this document. General-purpose computers, network appliances, mobile devices, or other electronic systems may also include at least portions of the system 500. The system 500 includes a processor 510, a memory 520, a storage device 530, and an input/output device 540. The apparatus may include disk storage and/or internal memory, each of which may be communicatively connected to each other. The apparatus 100 may include a processor 510. The processor 510 may enable both generic operating system (OS) functionality and/or application operations. In some embodiments, the processor 510 and the memory 520 may be communicatively connected. As used in this disclosure, “communicatively connected” means connected by way of a connection, attachment, or linkage between two or more elements which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components.

Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. In some embodiments, the processor 510 may include any computing device as described in this disclosure, including without limitation a microcontroller, microprocessor, digital signal processor (DSP) and/or system on a chip (SoC) as described in this disclosure. The processor 510 may include, be included in, and/or communicate with a mobile device such as a mobile telephone or smartphone. The processor 510 may include a single computing device operating independently, or may include two or more computing device operating in concert, in parallel, sequentially or the like. Two or more computing devices may be included together in a single computing device or in two or more computing devices. The processor 510 may interface or communicate with one or more additional devices as described below in further detail via a network interface device. Network interface device may be utilized for connecting the processor 510 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. The processor 510 may include but is not limited to, for example, a computing device or cluster of computing devices in a first location and a second computing device or cluster of computing devices in a second location. The processor 510 may include one or more computing devices dedicated to data storage, security, distribution of traffic for load balancing, and the like. The processor 510 may distribute one or more computing tasks as described below across a plurality of computing devices of computing device, which may operate in parallel, in series, redundantly, or in any other manner used for distribution of tasks or memory between computing devices. The processor 510 may be implemented using a “shared nothing” architecture in which data is cached at the worker, in an embodiment, this may enable scalability of system 500 and/or processor 510.

With continued reference to FIG. 5, processor 510 and/or a computing device may be designed and/or configured by memory 520 to perform any method, method step, or sequence of method steps in any embodiment described in this disclosure, in any order and with any degree of repetition. For instance, the processor 510 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The processor 510 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Each of the components 510, 520, 530, and 540 may be interconnected, for example, using a system bus 550. The processor 510 is capable of processing instructions for execution within the system 500. In some implementations, the processor 510 is a single-threaded processor. In some implementations, the processor 510 is a multi-threaded processor. In some implementations, the processor 510 is a programmable (or reprogrammable) general purpose microprocessor or microcontroller. The processor 510 is capable of processing instructions stored in the memory 520 or on the storage device 530.

The memory 520 stores information within the system 500. In some implementations, the memory 520 is a non-transitory computer-readable medium. In some implementations, the memory 520 is a volatile memory unit. In some implementations, the memory 520 is a non-volatile memory unit.

The storage device 530 is capable of providing mass storage for the system 500. In some implementations, the storage device 530 is a non-transitory computer-readable medium. In various different implementations, the storage device 530 may include, for example, a hard disk device, an optical disk device, a solid-date drive, a flash drive, or some other large capacity storage device. For example, the storage device may store long-term data (e.g., database data, file system data, etc.). The input/output device 540 provides input/output operations for the system 500. In some implementations, the input/output device 540 may include one or more network interface devices, e.g., an Ethernet card, a serial communication device, e.g., an RS-232 port, and/or a wireless interface device, e.g., an 802.11 card, a 3G wireless modem, or a 4G/5G wireless modem. In some implementations, the input/output device may include driver devices configured to receive input data and send output data to other input/output devices, e.g., keyboard, printer and display devices 560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 530 may be implemented in a distributed way over a network, for example as a server farm or a set of widely distributed servers, or may be implemented in a single computing device.

Although an example processing system has been described in FIG. 5, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, a data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

A user may also input commands and/or other information to computer system 500 via storage device 524 (e.g., a removable disk drive, a flash drive, etc.) and/or network interface device 540. A network interface device, such as network interface device 540, may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide graphical representations of aspects of the present disclosure. In addition to a display device, computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for mobile application encryption, comprising:
a mobile device having at least a sensor; and
a mobile application executable on the mobile device, the mobile application, upon execution, programmed to:
retrieve sensor data of the mobile device through the at least a sensor;
generate a secure data file within the mobile application, the secure data file configured to receive the sensor data;
transfer the sensor data directly into the secure data file, bypassing interaction with any default applications of the mobile device, the sensor data inaccessible to a default application of the mobile device; and
store the sensor data within the secure data file of the mobile application, wherein the secure data file is hidden from any of the default applications of the mobile device.

2. The apparatus of claim 1, wherein the mobile application is a camera application.

3. The apparatus of claim 1, wherein an operating system of the mobile device is unaware of the sensor data of the secure data file.

4. The apparatus of claim 1, wherein the sensor data includes a video, photograph, audio recording, or combination thereof.

5. The apparatus of claim 1, wherein the mobile application is further configured to determine metadata relating to the sensor data and store the metadata in the secure data file.

6. The apparatus of claim 1, wherein the mobile application is further configured to provide one or more user options to a user through a graphical user interface (GUI).

7. The apparatus of claim 6, wherein the mobile application is further configured to activate the at least a sensor of the mobile device in response to user input received through the GUI.

8. The apparatus of claim 1, wherein the secure data file is inaccessible to a user of the mobile device.

9. The apparatus of claim 1, wherein the mobile application is further programmed to generate the secure data file and retrieve the sensor data simultaneously.

10. The apparatus of claim 1, wherein the mobile application is further programmed to generate the secure data file before retrieving the sensor data.

11. A method of mobile application encryption using a computing device, comprising:
executing, a mobile application on a mobile device, the mobile device having at least a sensor;
retrieving, through the mobile application, sensor data of the mobile device through the at least a sensor;
generating, by the mobile application, a secure data file configured to receive the sensor data;
transferring, by the mobile application, the sensor data directly into the secure data file of the mobile application, bypassing interaction with any default applications of the mobile device, the sensor data inaccessible to any of the default applications of the mobile device; and
storing the sensor data within the secure data file of the mobile application, wherein the secure data file is hidden from an operating system of the mobile device.

12. The method of claim 11, wherein the mobile application is a camera application.

13. The method of claim 11, wherein an operating system of the mobile device is unaware of the sensor data of the secure data file.

14. The method of claim 11, wherein the sensor data includes a video, photograph, audio recording, or combination thereof.

15. The method of claim 11, further comprising determining, by the mobile application, metadata relating to the sensor data and storing the metadata in the secure data file.

16. The method of claim 11, further comprising providing one or more user options through a graphical user interface (GUI) of the mobile application.

17. The method of claim 16, further comprising activating the at least a sensor of the mobile device based on user input received through the GUI.

18. The method of claim 11, wherein the secure data file is inaccessible to a user of the mobile device.

19. The method of claim 11, further comprising generating the secure data file and retrieving the sensor data simultaneously by the mobile application.

20. The method of claim 11, further comprising generating, by the mobile application, the secure data file before retrieving the sensor data.
